(19) United States
(12) Patent Application Publication
(10) Pub. No.: US 2009/0301590 A1
(43) Pub. Date: Dec. 10, 2009

(54) Fuel shutoff slide valve

(75) Inventor: Evan Waymire, Oregon City, OR (US)

Correspondence Address: Ingrid McTaggart, 3021 SE 56th Ave., Portland, OR, 97206, US

(73) Assignee: MFB Investments, LLC

(21) Appl. No.: 12/455,162

(22) Filed: May 29, 2009

Related U.S. Application Data
(60) Provisional application No. 61/130,412, filed on May 29, 2008.

(51) Int. Cl. B60G 17/052

(52) U.S. Cl. 137/627.5

(57) ABSTRACT

A method of controlling fuel flow including providing a fuel tank including a first fuel port and a second fuel port on an exterior of the fuel tank, the first and second fuel ports each communicating with an interior of the fuel tank, positioning a first connector through a valve body and securing the first connector directly to the first fuel port, positioning a second connector through the valve body and securing the second connector directly to the second fuel port, and adjusting a positioned of a slide member on the valve body between a first position and a second position, the slide member in the first position simultaneously blocking fluid flow through the first fuel port and the second fuel port, and in the second position simultaneously allowing fluid flow through the first fuel port and the second fuel port.

This application claims priority on U.S. provisional Patent Application Ser. No. 61/130,412, filed on May 29, 2008, entitled FUEL SHUTOFF SLIDE VALVE, and hereby incorporated by reference herein.

### BACKGROUND OF THE INVENTION

Fuel tanks may include a fuel supply line for supplying fuel to an engine, and a fuel return line for returning unused fuel from the engine to the fuel tank. The fuel supply line and the fuel return line may each include a shutoff valve therein to prevent fuel flow when shutoff is desired. For safety reasons it may be desirable that the shutoff valve for the supply line and the shutoff valve for the return line both be closed or both be open and that a one-open/one-closed condition be avoided.

### SUMMARY OF THE INVENTION

The present invention provides a fuel shutoff slide valve that ensures that the fuel supply line and the fuel return line are always in the some condition, i.e., both open or both closed.

### BRIEF DESCRIPTION OF THE DRAWINGS

FIG. 1 is an isometric exploded view of one example embodiment of the slide valve.

FIG. 2 is a left side view of the slide valve.

FIG. 3 is a top view of the slide valve.

FIG. 4 is a front view of the slide valve.

FIG. 5 is a bottom view of the slide valve.

FIG. 6 is a right side view of the slide valve.

FIG. 7 is a bottom view of the slide valve in an open condition.

FIG. 8 is a bottom view of the slide valve in a closed condition.

FIG. 9 is a bottom view of the slide valve showing a cross-sectional line A-A.

FIG. 10 is a sectional view of the slide valve taken along line A-A of FIG. 9 and showing the valve secured to a fuel tank.

### DETAILED DESCRIPTION OF THE DRAWINGS

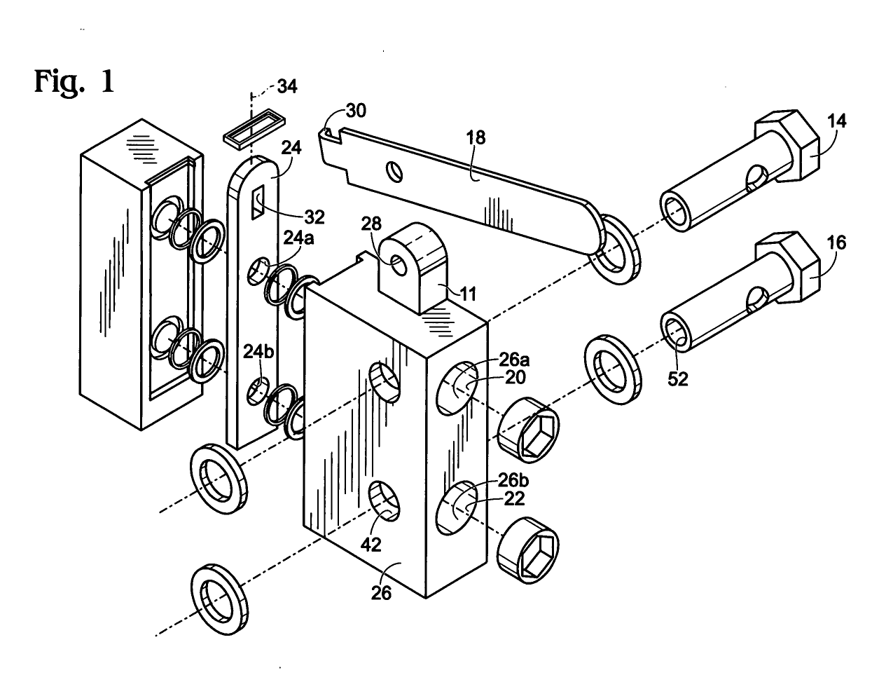

FIG. 1 is an isometric exploded view of one example embodiment of a fuel shutoff slide valve 11. The fuel shutoff valve 11 is a dual slide valve including a first fluid flow path 20 and a second fluid flow path 22, which may include a supply valve 24a and a return valve 24b positioned therein. Both valves 24a and 24b are simultaneously moved between the open and the closed position with a single operating handle 18 or lever. Actuating the handle 18, or lever, simultaneously opens or closes valves 24a and 24b, on the fuel supply and fuel return fluid flow paths 20 and 22 by sliding a slide plate 24 within a body 26 of valve 11. In particular, in the open position valve apertures 24a and 24b in the slide plate 24 are aligned with bores 26a and 26b within the body 26 and, in the closed position the apertures 24a and 24b are unaligned with the bores 26a and 26b, that define fluid flow paths 20 and 22.

The handle 18 pivots about a pivot point 28 such that a grooved end 30 of handle 18 positioned within a recess 32 of slide plate 24 will move slide plate 24 along a slide axis 34 between the fully open position to the fully closed position.

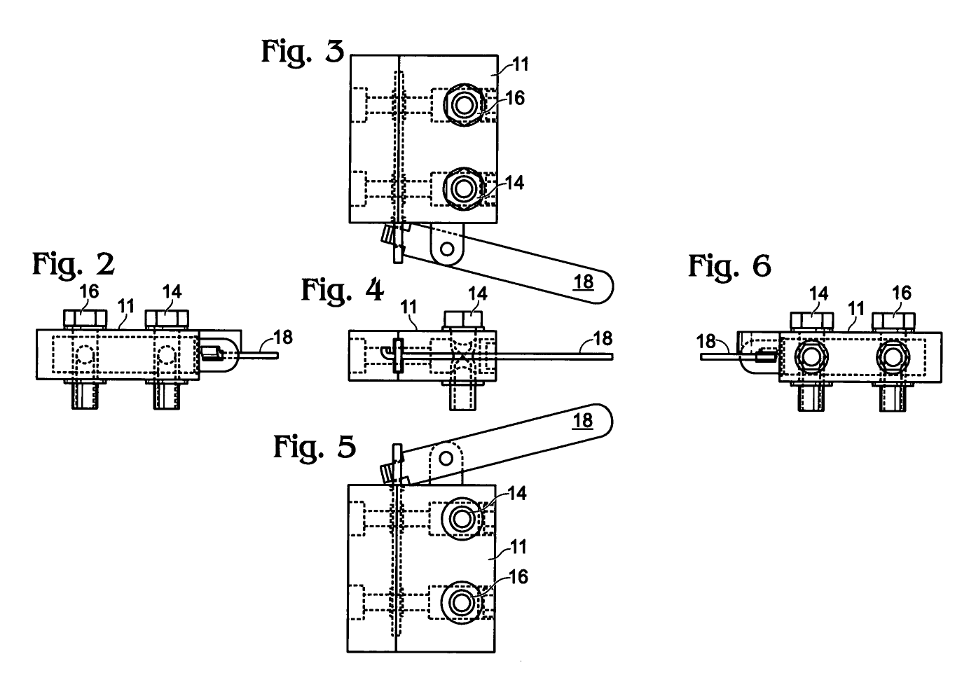

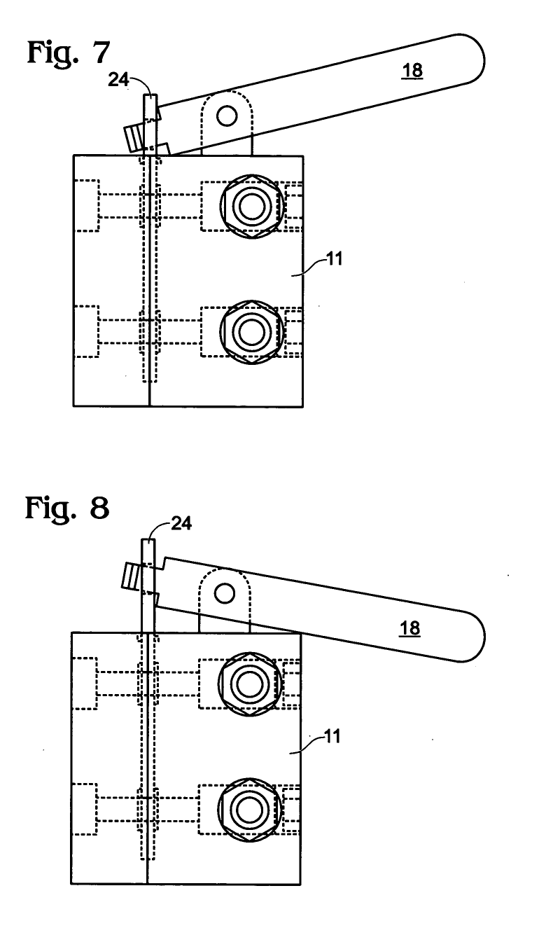

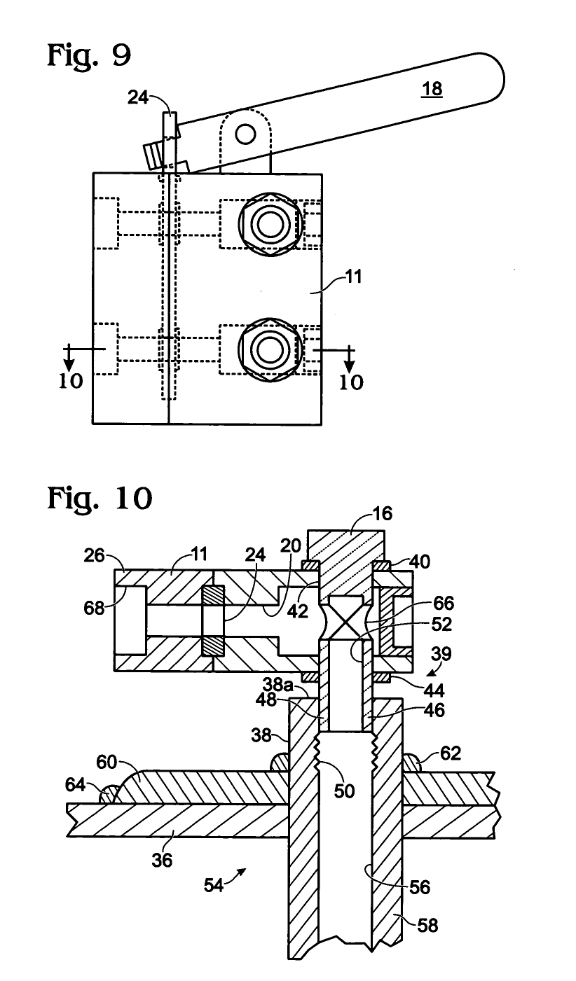

FIGS. 2-10 show other views of one example embodiment of the fuel shutoff slide valve of the present invention. In particular, FIG. 2 is a left side view of the slide valve. FIG. 3 is a top view of the slide valve. FIG. 4 is a front view of the slide valve. FIG. 5 is a bottom view of the slide valve. FIG. 6 is a right side view of the slide valve. FIG. 7 is a bottom view of the slide valve in an open condition. FIG. 8 is a bottom view of the slide valve in a closed condition. FIG. 9 is a bottom view of the slide valve showing a cross-sectional line A-A. FIG. 10 is a sectional view of the slide valve taken along line A-A of FIG. 9 and showing the valve secured to a fuel tank.

Still referring to FIG. 10, valve 11 is shown connected to a tank port 38 of tank 36 by a connector 16. During installation, connector 16 may be placed through a first sealing washer 40, an aperture 42 of valve body 11, and a second sealing washer 44. The valve body 11, with connector 16 extending through aperture 42, is then positioned adjacent tank port 38 and an end 46 of connector 16, having external threads 48 thereon, is secured on internal threads 50 of tank port 38. In one embodiment, connector 16 is tightened, such as by rotating connector 16 within tank port 38, until second sealing washer 44 abuts the top surface 38a of tank port 38. In this manner, a hollow interior 52 of connector 16 is fluidly engaged with an interior 54 of fuel tank 36 through the interior 56 of tank port 38. In the embodiment shown, tank port 38 is an end of a fuel return or a fuel supply tube 58 that extends downwardly into interior 54 of fuel tank 36. Tank port 38 may be secured to fuel tank 36 by securing tank port 38 to a flange 60, such as with a weld 62, and then securing the flange 60 to the tank 36, such as by another weld 64.

After valve 11 is secured to tank 36 at tank port 38 as described above, fluid may flow from tank 36 through interior 56 of tank port 38, through interior 52 of connector 16, through a side aperture 66 in connector 16, through aperture 20 of valve body 26, and out of valve body 26 through valve body aperture 68. A fuel hose (not shown) may be connected to valve body 26 at aperture 68 so as to direct a fuel flow outwardly of valve body 26 as desired. Similarly, fluid may flow along the same path in an opposite direction so as to flow into interior 54 of fuel tank 36 as desired.

Similarly, tank connector 14 is connected to fuel tank 36 at another tank port adjacent to tank port 38, using the same installation procedure. In this manner, valve 11 may be utilized to simultaneously connect to a draw tank port and to a return tank port without utilizing flexible tubing of hoses between the tank 38 and the valve body 26. Accordingly, in an embodiment wherein valve body 26 is manufactured from a solid, rigid material, such as cast from a unitary block of steel, for example, and wherein tank port 38 may be manufactured of a somewhat rigid tubing such as non-flexible steel tubing, the valve 11 may provide a sturdy valve connection that does not utilize hoses or flexible tubing between the tank port 38 and the valve 11, and which also provide simultaneous movement of valves 24a and 24b between the open and the closed positions thereby avoiding a one-open/one-closed condition of the two valves 24a and 24b.

Accordingly, valve 11 is designed to attach directly to supply port 38 and to return port 39 (positioned behind port 38 in the view of FIG. 10) of fuel tank 36 without needing any hoses between the fuel tank 36 and the valve 11. Connections between the valve 11 and tank ports 38 and 39 is accomplished through connectors 14 and 16, which in the embodiment shown are banjo bolts 14 and 16, which pass through the valve body 26 and connect to the fuel tank's 36 supply and return ports 38 and 39. The use of banjo bolts allows the body 26 of the valve 11 to be mounted directly on a fuel tank 36 thereby reducing or eliminating the use of a separate mounting bracket for the valve 11 and reducing or eliminating the use of hoses or pipes from the valve 11 to the fuel tank 36.

The valve 11 may be mounted on a fuel tank 36 with either of banjo bolts 14 or 16 secured to a draw tube port 38 of a fuel tank, for example, and with the other banjo bolt secured to a return tube port of a fuel tank, for example, merely by positioning valve body 26 as desired. In other words, the valve 11 may be positioned on a left-hand or a right-hand fuel tank of a dual fuel tank tractor trailer, for example, so that handle 18 of the valve 11 may be positioned laterally outboard with respect to a longitudinal axis of the tractor trailer.

Accordingly, the embodiment shown has the advantages of simultaneous shutoff of both the supply and return fuel passages 20 and 22 with one handle element 18, and direct attachment of the valve 11 to a fuel tank 36 supply port 38 and a fuel tank return port 39 without the use of external mounting brackets or hoses to connect the valve to the tank. This arrangement may reduce installation time because fewer parts are connected to the fuel tank, may reduce the manufacturing costs because fewer parts are utilized, and may reduce maintenance costs in use because prior art elements that may malfunction, such as hoses connecting valves to a fuel tank, have been eliminated by the current valve system. Moreover, the simultaneous closing and opening operation of the current valve 11 may reduce safety concerns that the valve may be left in a one-open/one-closed condition.

I claim:

1. A fuel shutoff system, comprising:
a body;
a first fluid flow path extending through said body;
a second fluid flow path extending through said body, different from said first fluid flow path; and
a single valve element that extends through said body, said single valve element structured for sliding movement between a first position and a second position, wherein in said first position said first and second fluid flow paths are unblocked, and wherein in said second position said first and second fluid flow paths are blocked by said single valve element.

2. The system of claim 1 further comprising a fuel tank including a first fuel flow port directly fluidly connected to said first fluid flow path of said body, and a second fuel flow port directly fluidly connected to said second fluid flow path of said body.

3. The system of claim 2 further comprising a first banjo bolt secured through said body and a second banjo bolt secured through said body, said first banjo bolt defining at least a portion of said first fluid flow path and being directly connected to said first fuel flow port, and a second banjo bolt secured through said body, said second banjo bolt defining at least a portion of said second fluid flow path and being directly connected to said second fuel flow port.

4. The system of claim 3 wherein said body, said first and second fluid flow ports, and said first and second banjo bolts are each manufactured of non-flexible material.

5. The system of claim 3 wherein said first banjo bolt is threadably connected to said first fuel flow port and wherein said second banjo bolt is threadably connected to said second fuel flow port.

6. The system of claim 2 wherein said body is directly connected to said fuel flow ports of said fuel tank with an absence of a mounting bracket, and with an absence of a flexible hose positioned between each of said fluid flow paths of said body and said fuel tank.

7. The system of claim 3 wherein said body, said first and second banjo bolts, and said first and second fuel flow ports are each manufactured of a non-flexible material.

8. The system of claim 2 wherein said first fluid flow path of said body is structured to be fluidly connected to either of said first and second fuel flow ports of said fuel tank, and wherein said second fluid flow path of said body is structured to be connected to the other of said first and second fuel flow ports of said fuel tank, such that a handle mounted on said body and which operates said single valve element is positioned in an outboard position on said fuel tank, and wherein said fuel tank is chosen from one of right-hand fuel tank and a left-hand fuel tank.

9. A fuel shutoff system, comprising:
a fuel tank including a rigid first fuel flow port and a rigid second fuel flow port; and
a fuel valve including a rigid first connector directly connected to said first fuel flow port and defining a first fluid flow path, and a rigid second connector directly connected to said second fuel flow port and defining a second fluid flow path.

10. The system of claim 9 wherein said fuel valve further comprises a slide member that extends through said body, said slide member structured for sliding movement between a first position and a second position, wherein in said first position said first and second fluid flow paths are unblocked, and wherein in said second position said first and second fluid flow paths are blocked by said slide member.

11. The system of claim 9 wherein movement of said slide member simultaneously moves said first and second fluid flow paths between the blocked and unblocked positions.

12. The system of claim 9 wherein said fuel tank, said fuel valve, said first connector, and said second connector are each manufactured of inflexible steel.

13. The system of claim 10 further comprising a handle secured to said slide member for actuating sliding movement of said slide member on said body.

14. A method of controlling fuel flow, comprising:
providing a fuel tank including a first fuel port and a second fuel port on an exterior of said fuel tank, said first and second fuel ports each communicating with an interior of said fuel tank;
positioning a first connector through a valve body and securing said first connector directly to said first fuel port;
positioning a second connector through said valve body and securing said second connector directly to said second fuel port; and
adjusting a position of a slide member on said valve body between a first position and a second position, said slide member in said first position simultaneously blocking fluid flow through said first fuel port and said second fuel port, and in said second position simultaneously allowing fluid flow through said first fuel port and said second fuel port.

15. The method of claim 14 wherein said valve body defines first and second fluid flow paths, and wherein said first connector defines at least a portion of said first fluid flow path, and wherein said second connector defines at least a portion of said second fluid flow path.

16. The method of claim 14 wherein said first and second connectors are rigid banjo bolts.
